(19) United States
(12) Patent Application Publication
(10) Pub. No.: US 2011/0276281 A1
(43) Pub. Date: Nov. 10, 2011

(54) APPARATUS FOR DETERMINING AND/OR MONITORING A PROCESS VARIABLE OF A MEDIUM

(75) Inventor: Armin Wernet, Rheinfelden (DE)

(73) Assignee: Endress + Hauser GmbH + Co. KG, Maulburg (DE)

(21) Appl. No.: 13/127,260

(22) PCT Filed: Oct. 27, 2009
(86) PCT No.: PCT/EP2009/064128

§ 371 Date: Jul. 22, 2011

(30) Foreign Application Priority Data
Nov. 3, 2008 (DE) 102008043412.4

(51) Int. Cl. G06F 19/00; G01F 23/00

(52) U.S. Cl. 702/55

(57) ABSTRACT

An apparatus for determining and/or monitoring at least one process variable of a medium. The apparatus includes: at least one evaluation unit, which monitors and/or signals an exceeding and/or subceeding of a predeterminable limit value of the process variable by the medium; and at least one memory unit, in which limit values of the process variable associated with at least one property of the medium are stored; and wherein the evaluation unit, based on information concerning the property of the medium, applies from the memory unit, for determining and/or monitoring the process variable, a stored limit value associated with the property of the medium.

The invention relates to an apparatus for determining and/or monitoring at least one process variable of a medium. The process variable is, for example, the fill level.

In the state of the art, it is, for example, known to monitor the fill level of a medium by detecting whether an electrical contact exists through the medium between a probe electrode and the wall of a conductive container or a second electrode. Since, in the case of many media, an accretion can form on the probe unit, so-called guard or reference electrodes are used, which are connected to the same electrical potential as the probe electrode, and surround the probe electrode (see e.g. DE 32 12 434 C2). Depending on the character of the accretion, it is, however, possible that difficulties occur in suitably producing the guard or reference signal.

Thus, an object of the invention is to provide a measuring device, in the case of which, over a wide range, an insensitivity to accretions is provided.

The invention achieves the object with an apparatus for determining and/or monitoring at least one process variable of a medium, comprising: At least one evaluation unit, which monitors and/or signals an exceeding and/or subceeding of a predeterminable limit value of the process variable by the medium; and at least one memory unit, in which limit values of the process variable associated with at least one property of the medium are stored; and wherein the evaluation unit, based on information concerning the property of the medium, applies from the memory unit, for determining and/or monitoring the process variable, a stored limit value associated with the property of the medium. The measuring device thus involves a so-called limit level switch, in the case of which the limit value for producing the switch signal for the particular medium is selected from a memory unit. For such purpose, at least one property of the medium is ascertained. Thus, the limit value for the measured value can be established with regard to the particular medium in such a manner, that an accretion on the measuring device especially does not prevent secure switching, and thus also does not prevent the displaying of the reaching or subceeding of the limit value. Since an accretion generally corrupts the measurement signal and thus reflects an incorrect process variable, the limit value is preferably placed in such a manner, that it lies outside of the range for the measurement signal which would be reachable through the accretion. The apparatus can, in such case, be a capacitive or conductive fill level measuring device, or, for example, a measuring device based on vibronics (an oscillatory fork or a single rod, or membrane, oscillator).

In other words: The reaching of a value of the process variable is recognized in that a measurement signal reaches a corresponding (limit-) value, which is associated with the value of the process variable. This association between the process variable and measurement signal is, however, dependent on at least one property of the medium. Therefore, the suitable limit value used for the measurement signal is based on this property, wherein this limit value for the measurement signal corresponds to the desired limit value for the process variable. This brings the advantage that a complex calibration procedure can be omitted, since the optimal switching point can be ascertained, or calculated, from the registered properties of the medium, and thus also automatically adjusts to changing media (for example, also cleaning procedures CIP, SIP) in the container or pipe system.

An embodiment provides that at least one measuring unit for determining and/or monitoring the property of the medium is provided. In an embodiment, the measuring unit is a unit separate from the apparatus of the invention. In an additional embodiment, the measuring unit is a component of the apparatus, or the apparatus of the invention itself serves as a measuring unit for determining and/or monitoring the property of the medium.

An embodiment includes that at least one electronics unit is provided; that at least one probe unit is provided, which the electronics unit supplies with an operating signal and from which the electronics unit receives a received signal; and that the evaluation unit ascertains from the received signal information concerning the process variable. The operating signal is, in such case, for example, an alternating voltage, which is provided on the probe unit or at least one component of the probe unit, and the received signal is the electrical current signal or an electrical voltage corresponding thereto, which can be tapped from the probe unit or from at least by one component the probe unit. This embodiment thus especially involves a capacitive, or conductive, fill level switch. In the state of the art, such limit switches are either delivered with a standard calibration which can cover the entire product spectrum, or spectrum of the medium, without recalibration, or the customer must itself calibrate the device for the medium to be measured on-site, i.e. in the installed state, via calibration, for example, via a potentiometer) A new calibration represents, in such case, an extra effort, especially since the fill level of the medium associated with the limit level must be brought about, a circumstance which is not desirable. A standard calibration on the part of the manufacturer generally has the disadvantage that, in the case of a fouling of the probe unit, or in the case of accretion clinging to the probe unit, a measuring device calibrated in such a manner leads relatively rapidly to a switching malfunction.

An embodiment provides that the evaluation unit ascertains from the received signal information concerning the property of the medium.

An embodiment includes that the probe unit has at least a sensor electrode and a guard electrode. Another name for a guard electrode is “compensating electrode”, wherein the name also reflects the particular application or the type of supplying with one or more signals. The guard electrode serves in one embodiment as a reference electrode, via which the state of loading of the probe unit by the medium is continually monitored, wherein, for example, via the ratio of the reference voltage—thus the voltage sensed from the reference electrode—to the measured voltage—thus the voltage sensed from the sensor electrode as the received signal after the supplying with the operating signal—a “free”, or “covered”, report is produced, i.e. the subceeding, or exceeding, of the limit value is displayed.

An embodiment provides that the guard electrode is embodied essentially cylindrically, and that the sensor electrode is arranged within the essentially cylindrically embodied guard electrode. In such case, in an embodiment, the guard electrode serves especially also as a reference electrode. The construction described here corresponds, in such case, especially to a construction described in the Offenlegungsschrift DE 10 2007 003 887 A1.

An embodiment provides that the evaluation unit, based on the received signal accompanying a subceeding of the limit value, deduces a degree of covering of the probe unit by accretion. Due to accretion, in the state, “not covered by medium”, there most often results a signal, or measured voltage, which differs from the signal, or voltage corresponding to the actual “free” state. In such case, the thickness of the accretion also has a noticeable effect. Therefore, from, for example, a change in the accretion signal for the uncovered state, an increasing accretion thickness can be inferred, so that a predictive maintenance can also be indicated. If a measured value lies very near to the switching point or limit value and remains there, a warning report can then be output, which requests a cleaning of the probe.

An embodiment includes that the process variable is fill level of the medium within a container.

An embodiment provides that the property of the medium is the electrical conductivity of the medium.

The invention will now be explained in greater detail on the basis of the appended drawing, the figures of which show as follows:

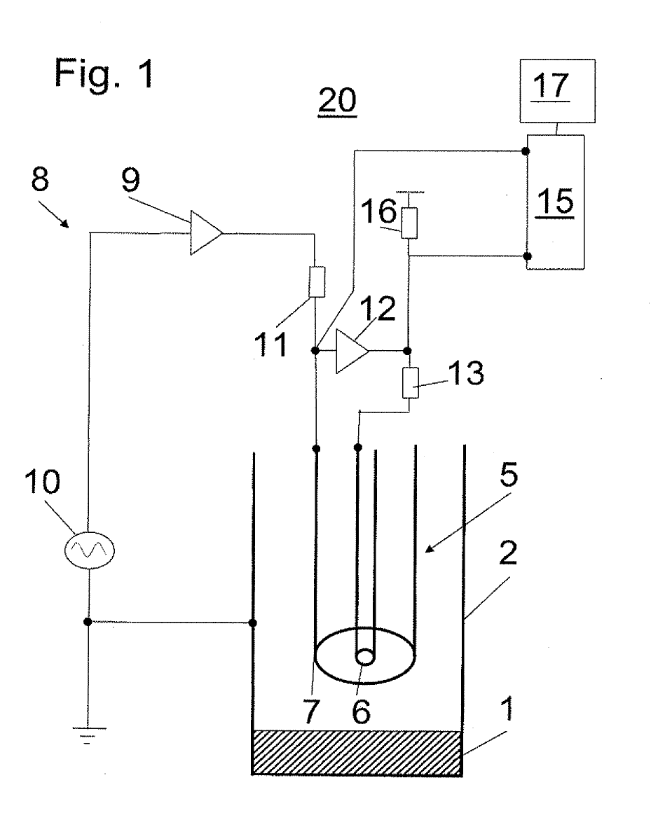

FIG. 1 a schematic representation of the application of a measuring device of the invention, and

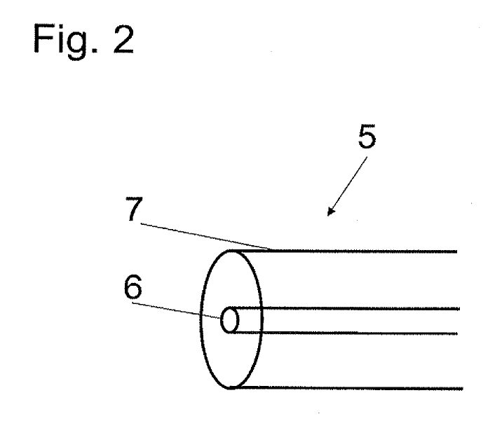

FIG. 2 a schematic drawing of a section of a probe unit.

In FIG. 1, the fill level of a medium 1 within a container 2 is being monitored. The medium 1 is, in such case, preferably an electrically conductive liquid. Application in the case of electrically non-conductive media is likewise possible. The measuring device is composed of an electronics unit 8 and a probe unit 5. In a practical embodiment, the probe unit 5 is, in such case, preferably installed into a wall, e.g. a lid, of the container 2 in such a manner, that the wall directly forms a seal with it. The container 2 may be, for example, also a pipe, through which the medium 1 flows; the term “the container” can thus be understood to mean any type of structure which, at least at times, accommodates a medium. The wall of the container 2 is here embodied as ground electrode, i.e. it is connected with a ground potential in an electrically conducting manner. Alternatively, a second electrode is installed in the container 2. Likewise connected with ground is a signal source 10, which produces, especially, an electrical, alternating voltage signal as an operating signal, which is supplied to the sensor electrode 6. If the medium 1—which is electrically conductive—reaches a fill level which is predetermined by the structure of the probe unit 5 and its position within, or on, the container 2, an electrical contact between the sensor electrode 6 and the wall of the container 2 is then produced, which results, for example, in a change in electrical current, which can be read from the sensor electrode 6 as a received signal.

A problem arises, for example, when the medium 1 sinks down, and, in such case, medium remains clinging on the probe unit 5 as accretion. If, for example, the entire wall of the container 2 is connected in an electrically conducting manner with ground and the accretion extends from the sensor electrode 6 to the wall, an erroneous reading then occurs on the display, since the covered state is then still displayed. In order to avoid this problem of accretion, a so-called guard electrode 7 is provided, which preferably surrounds the sensor electrode 6 coaxially at least in the region in which the sensor electrode comes in contact with the medium 1. In such case, an insulator is usually provided in the probe unit 5 between the sensor electrode 6 and the guard electrode 7. The guard electrode 7 is supplied here via a first amplifying unit 9 with a guard signal. In such case, the probe signal and the guard signal preferably have equal phase and equal amplitude. If an accretion is located on the probe unit 5, the guard electrode 7 then drives an alternating electrical current to the counterelectrode (this is here, for example, the grounded wall of the container 2, or, in an alternative embodiment, a second, additional electrode) and raises the accretion covering the electrode ideally to the electrical potential of the guard electrode 7. An electrical current flow from the probe electrode 6 to the counterelectrode 2 is then prevented, since the accretion surrounding the probe electrode is raised by the guard electrode to the electrical potential of the probe electrode.

The signal of the signal source 10—which, in such case, can be any alternating signal—is supplied by the amplifying unit 9 to the guard electrode 7 via a limiting element 11—here an ohmic resistor. The resistance of the limiting element 11 is to be chosen so as to be greater than the internal resistance of the amplifying unit 9. Through the limiting element 11, it is prevented that the amplifier 9 participates in the the limiting. The guard signal is preferably fed as a reference signal or as a reference voltage for evaluating or determining the fill level to the evaluation unit 15, where it is, for example, digitized by an analog/digital converter, which, in given cases, is also a component of a microprocessor. Furthermore, the guard signal is fed to an amplifying unit, which here serves as an isolating element 12—which especially also fulfills the duties of an impedance converter—for preventing feedback. The amplification of isolating unit 12 is, for example, set equal to one. The guard signal reaches the sensor electrode 6 as the operating signal via the probe electrical current limiting element 13. The probe electrical current limiting element 13 is, in such case, preferably also an ohmic resistor, which prevents, in the case of very conductive media, the probe electrical current from being too large, and therewith, for example, from lying outside of the range of the analog/digital converter. The operating signal is, in given cases, also fed to the evaluation unit 15, in order, for example, likewise to be digitized. In an embodiment, during the evaluation, the ratio between the guard signal and the received signal is evaluated or compared with the predeterminable limit value.

According to the invention, the evaluation unit 15 is connected with a memory unit 17, in which limit values are stored. The limit values are stored, in such case, for example, via a formula or in the form of a table. In such case, the limit values are preferably stored as a function of at least one property of the media to be measured; here, the property is especially the electrical conductivity of the media. Depending on the ascertained conductivity value, the limit value suitable therefor is then extracted from the memory unit 17, and, as a function of this value, during the course of operation, the reaching or subceeding of the fill level of the medium associated with the limit value is then signaled.

In order to obtain the data, measurement data for the “free” case and for the “covered” case without an accretion are preferably recorded during the manufacturing. Preferably, the measurement data can be described with a mathematical function. In order to assure a secure switching, a switching point line is specified at a defined distance above the covered line, and stored as a function or as individual data in the memory unit 17. This occurs, for example, in the manufacturing plant for determined probe geometries.

It is found that the more conductive the medium, the more the reference voltage, i.e., that of the guard electrode 7 serving here as reference electrode, decreases.

FIG. 2 illustrates the construction of the probe unit 5: The guard or reference electrode 7 is embodied cylindrically and surrounds the sensor electrode 6, which here is arranged in the center of the former. Shown in such case is the end surface of the probe unit 5, in which the guard electrode 7 appears as the rim of the area into whose center the sensor electrode 6 extends.

Start-up of a measuring device of the invention thus occurs, for example, through steps as follows:

The evaluation unit 15 works first with the limit value representing the difference relative to air. This triggers a signal when the probe unit 5 becomes covered with any medium. If a covering by medium occurs, an impedance measurement or a conductivity measurement of the medium is then performed via the guard electrode 7, i.e. it is initially determined what kind of medium is being measured. From the ascertained guard voltage or from the conductivity measurement, the associated limit value is then extracted from the memory unit 17. The probe signal is evaluated with reference to the ascertained limit value, and results in a “free” senor report or a “covered” sensor report. The limit value is set, in such case, in such a manner, that even an accretion of the medium does not prevent that, in the case of the subceeding of the fill level associated with the limit value, a signal is produced that the sensor is free of medium.

Some advantages are thus that, on the one hand, no knowingly brought about calibrating is required, but rather the calibrating and the optimizing for the present medium is instead performed automatically in direct operation by the measuring device; and that, on the other hand, the limit value for the medium is specific, and is predetermined in such a manner, that an accretion does not impair the switching of the measuring device.

### LIST OF REFERENCE CHARACTERS

1 medium

2 container

5 probe unit

6 sensor electrode

7 guard electrode

8 electronics unit

9 amplifying unit

10 signal source

11 limiting element

12 isolating unit

13 probe electrical current limiting element

15 evaluation unit

16 measuring resistor for sensor electrode electrical current

17 memory unit

20 measuring unit

1-9. (canceled)

10. An apparatus for determining and/or monitoring at least one process variable of a medium, comprising:
at least one evaluation unit, which monitors and/or signals an exceeding and/or subceeding of a predeterminable limit value of the process variable by the medium; and
at least one memory unit, in which limit values of the process variable associated with at least one property of the medium are stored, wherein:
said at least one evaluation unit, based on information concerning the property of the medium, applies from said at least one memory unit, for determining and/or monitoring the process variable, a stored limit value associated with the property of the medium.

11. The apparatus as claimed in claim 10, further comprising:
at least one measuring unit 10 for determining and/or monitoring the property of the medium.

12. The apparatus as claimed in claim 10, further comprising:
at least one electronics unit; and
at least one probe unit, which said at least one electronics unit supplies with an operating signal and from which said at least one electronics unit receives a received signal; wherein:
said at least one evaluation unit ascertains from the received signal information concerning the process variable.

13. The apparatus as claimed in claim 12, wherein:
said at least one evaluation unit ascertains from the received signal information concerning the property of the medium.

14. The apparatus as claimed in claim 12, wherein:
said at least one probe unit has at least one sensor electrode and a guard electrode.

15. The apparatus as claimed in claim 14, wherein:
said guard electrode is embodied essentially cylindrically; and
said sensor electrode is arranged within said essentially cylindrically embodied guard electrode.

16. The apparatus as claimed in claim 12, wherein:
said at least one evaluation unit, based on the received signal which accompanies the subceeding of the limit value, deduces a degree of covering of said at least one probe unit by accretion.

17. The apparatus as claimed in claim 10, wherein:
the process variable is fill level of medium within a container.

18. The apparatus as claimed in claim 10, wherein:
the property of the medium is electrical conductivity of the medium.
